(19) United States
(12) Patent Application Publication
(10) Pub. No.: US 2023/0172153 A1
(43) Pub. Date: Jun. 8, 2023

(54) LITTER POD SYSTEM

(71) Applicant: Church & Dwight Co., Inc., Princeton, NJ (US)

(72) Inventors: Jonathan Wharton, Ewing, NJ (US); Sergio Gedanke, Brooklyn, NY (US); Mark E. Ventura, Freehold, NJ (US); Frank Edward Lindsay, Hamilton, NJ (US); Wayne E. Ford, Yardville, NJ (US); Roger Bruno, Beachwood, NJ (US)

(73) Assignee: Church & Dwight Co., Inc., Princeton, NJ (US)

(21) Appl. No.: 17/924,581

(22) PCT Filed: May 17, 2021
(86) PCT No.: PCT/US2021/032756

§ 371 Date: Nov. 10, 2022

Related U.S. Application Data
(60) Provisional application No. 63/027,089, filed on May 19, 2020.

(51) Int. Cl. A01K 1/01

(52) U.S. Cl. CPC A01K 1/0107

(57) ABSTRACT

The present disclosure provides a litter pod system, and methods of using litter pod systems. In some embodiments, the litter pod system may include a litter pod formed at least partially of a flexible, polymer material, the litter pod defining a substantially flat pod bottom wall with a pod side wall extending upwardly therefrom, and a housing base configured to receive the litter pod, the housing base being formed of a substantially rigid polymer material defining a housing bottom wall with a housing side wall extending upwardly therefrom.

### FIELD OF THE DISCLOSURE

The present disclosure relates to litter box systems capable of containing adsorbent compositions used as animal litter and methods of production of litter box systems, as well as their use as an animal litter box.

### BACKGROUND

Various types of litters have been used for many years in the area of pet care to provide a dedicated location for housebroken animals, such as cats, to urinate and defecate indoors. Litters generally can be formed of a liquid-absorbing material, such as clay, to provide for efficient absorption of urine. Litters further can include a variety of added materials, such as clumping aids, fragrances, and the like. The most commonly used litter box liquid-absorbing materials are inexpensive clays, such as calcined clays, that are safe and non-irritating to the animals, and that absorb substantial amounts of liquids. Other porous, solid litter box absorbent materials, that are used alone or in combination, include straw, sawdust, wood chips, wood shavings, porous polymeric beads, shredded paper, sand, bark, cloth, ground corn husks, and cellulose. Each of these absorbent materials has the advantage of low cost.

Litters as described above are typically providing in the form a disposable box or container that is intended to house the litter compositions during use and then disposed of after a time. The entire contents of the litter box including the soiled and unsoiled liquid-absorbing materials will eventually be removed because of the offensive odor caused by the absorbed urine and feces in the liquid-absorbing materials in the litter box. Litter boxes and systems typically suffer from poor performance related to accumulation and sticking of litter clumps to the box or container, offensive odor production, messy or unsanitary disposal techniques, poor functional design, and/or difficulty cleaning. Accordingly, there remains a need for improved litter box systems that particularly exhibit enhanced performance characteristics.

### SUMMARY OF THE DISCLOSURE

The present disclosure relates to animal litter box systems having enhanced performance characteristics, and related methods. In some embodiments, litter pod systems according to the present disclosure may comprise a litter pod formed at least partially of a flexible, polymer material, the litter pod defining a substantially flat pod bottom with a pod side wall extending upward therefrom, a housing base configured to receive the litter pod, the housing base being formed of a substantially rigid polymer material defining a housing bottom wall and a housing side wall extending upwardly therefrom, and a gap defining a clearance between the pod bottom wall and the housing bottom wall. In some embodiments, the pod side wall and the housing side wall both comprise a pair of longitudinal walls and a pair of transverse walls. In some embodiments, one of the longitudinal walls or one of the transverse walls in the housing side wall is absent forming an open face. In some embodiments, the housing bottom wall defines an upwardly curved edge proximate to the open face.

In some embodiments, the base may further comprise two or more housing chamfers positioned at opposing corner joints of the housing bottom wall and the housing side wall. In some embodiments, the litter pod further comprises two or more pod chamfers positioned at opposing corner joints of the pod bottom wall and the pod side wall. In some embodiments, the housing chamfers and the pod chamfers may be substantially triangular in shape. In some embodiments, the housing chamfers may be configured to engage the pod chamfers when the housing base and the litter pod are in a coupled configuration. In some embodiments, the pod side wall may define a plurality of ribs that protrude out from the pod side wall toward the interior of the litter pod. In some embodiments, the housing base may further comprise a ridge that protrudes out from the housing bottom wall, the ridge being configured to abut the housing bottom wall. In some embodiments, the ridge may comprise a plurality of ridges or bumps.

In some embodiments, the housing side wall may comprise one or more gripping zones on the exterior surface of the housing side wall. In some embodiments, the housing side wall may further comprise a tapered flange extending outward from a top perimeter of the housing side wall. In some embodiments, the pod side wall may further comprise a lip extending outward from a top perimeter of the pod side wall. In some embodiments, the tapered flange may define a channel for connection with a lip of the pod side wall. In some embodiments, the tapered flange may further comprise two cut outs on opposing sides of the housing side wall.

In some embodiments, the litter pod system further comprises an upper frame and/or a hood assembly. In some embodiments, one or both of the upper frame and the hood assembly may be configured to be directly connected to the base via the tapered flange. In some embodiments, the upper frame may define an outer wall and a skirt portion configured to cover at least a portion of the housing side wall when the upper frame is in direct connection with the base. In some embodiments, one or both of the flexible, polymer material and the substantially rigid polymer material are selected from the group consisting of polyethylene terephthalate (PET), polytetrafluoroethylene (PTFE), high-density polyethylene (HDPE), low-density polyethylene (LDPE), polyvinyl chloride (PVC), polypropylene (PP), polystyrene (PS), polyethylene (PE), acrylonitrile butadiene styrene (ABS), and combinations thereof. In some embodiments, one or both of the flexible polymer material and the substantially rigid polymer material have a Shore D Hardness of at least about 50. In some embodiments, one or both of the flexible, polymer material and the substantially rigid polymer material have a contact angle of at least about 70. In some embodiments, one or both of the flexible, polymer material and the substantially rigid polymer material comprise one or more additives or surface coatings. In some embodiments, the flexible, polymer material has a thickness in the range of about 0.01 mm to about 1.0 mm. In some embodiments, the substantially rigid polymer material has a thickness in the range of about 1.25 mm to about 5.0 mm. In some embodiments, the litter pod is formed of a fiber-based material that has been at least partially coated by the flexible, polymer material. In such embodiments, the fiber-based material is generally paper or paperboard formed of natural or synthetic fibers.

In one or more embodiments, the present disclosure specifically can relate to a litter pod system, comprising: a litter pod formed at least partially of a flexible, polymer material, the litter pod defining a substantially flat pod bottom wall with a pod side wall extending upwardly therefrom; a housing base configured to receive the litter pod, the housing base being formed of a substantially rigid polymer material defining a housing bottom wall and a housing side wall extending upwardly therefrom; and a gap defining a clearance between the pod bottom and the housing bottom wall. The litter pod system further may be defined in relation to one or more of the following statements, which may be combined in any number and/or order as would be immediately recognizable based upon the totality of the present disclosure.

The pod side wall and the housing side wall both can comprise a pair of longitudinal walls and a pair of transverse walls.

One of the longitudinal walls or one of the transverse walls forming the housing side wall can be absent so as to define an open face.

The housing bottom wall can define an upwardly curved edge proximate to the open face.

The housing base further can comprise two or more housing chamfers positioned at opposing corner joints of the housing bottom wall and the housing side wall.

The litter pod further can comprise two or more pod chamfers positioned at opposing corner joints of the pod bottom wall and the pod side wall.

The housing chamfers and the pod chamfers can be substantially triangular in shape.

The housing chamfers and the pod chamfers are can be configured for engagement therebetween.

The pod side wall can define a plurality of ribs that protrude from the pod side wall toward the interior of the litter pod.

The housing base further can comprise a ridge that protrudes out of the housing bottom wall, the ridge being configured to abut the housing bottom wall.

The ridge can comprise a plurality of ridges or bumps.

The housing side wall can comprise one or more gripping zones on the exterior surface of the housing side wall.

The housing side wall further can comprise a tapered flange extending outward from a top perimeter of the housing side wall.

The pod side wall further can comprise a lip extending outward from a top perimeter of the pod side wall.

The tapered flange can define a channel for connection with the lip of the pod side wall.

The tapered flange further can comprise two cut outs on opposing sides of the base side wall.

The litter pod system further can comprise one or both of an upper frame and a hood assembly.

The or both of the upper frame and the hood assembly can be configured to be directly connected to the housing base.

The upper frame can define an outer wall and a skirt portion configured to cover at least a portion of the housing side wall when the upper frame is in direct connection with the housing base.

The upper frame further can comprise one or more gripping zones on the exterior surface of the outer wall.

A top perimeter of the outer wall can define an inwardly curved edge.

The hood assembly can comprise an outer shell with at least one opening defining an animal entry-way.

The hood assembly further can comprise one or more vents defined by one or more openings in the outer shell.

The litter pod can be disposable and replaceable.

One or both of the flexible, polymer material and the substantially rigid polymer material can be selected from the group consisting of polyethylene terephthalate (PET), polytetrafluoroethylene (PTFE), high-density polyethylene (HDPE), low-density polyethylene (LDPE), polyvinyl chloride (PVC), polypropylene (PP), polystyrene (PS), polyethylene (PE), acrylonitrile butadiene styrene (ABS), and combinations thereof.

One or both of the flexible polymer material and the substantially rigid polymer material can have a Shore D Hardness of at least about 50.

One or both of the flexible, polymer material and the substantially rigid polymer material can have a contact angle of at least about 70.

One or both of the flexible, polymer material and the substantially rigid polymer material can comprise one or more additives or surface coatings.

The flexible, polymer material can have a thickness in the range of about 0.01 mm to about 1.0 mm.

The substantially rigid polymer material can have a thickness in the range of about 1.25 mm to about 5.0 mm.

The litter pod can be formed of a fiber-based material that has been at least partially coated by the flexible, polymer material.

The fiber-based material can be paper or paperboard formed of natural or synthetic fibers.

The litter pod can be pre-filled with animal litter.

The pre-filled litter pod can comprise a removable cover configured to seal the pre-filled litter pod along a top perimeter of the pod side wall prior to removal of the cover.

In one or more embodiments, the present disclosure specifically can relate to a method of assembling a litter pod system, the method comprising: providing a housing base, an upper frame, and a disposable litter pod pre-filled with animal litter, the housing base being configured to receive the disposable litter pod; inserting the disposable litter pod into the housing base such that the disposable litter pod is releasably secured by the base portion in a coupled configuration; positioning an upper frame overtop the housing base and the disposable litter pod while in a coupled configuration; and applying pressure to the upper frame to secure the upper frame to the housing base. In some embodiments, the method further can comprise providing a hood assembly configured to be secured to the upper frame.

In one or more embodiments, the present disclosure specifically can relate to a method of disposing of animal litter from a litter pod system, the method comprising: providing a housing base configured to receive a disposable litter pod; inserting a disposable litter pod in the housing base to form a litter pod system; lifting the litter pod system and tilting the housing base toward a disposal area such that the litter pod is deposited in the disposal area; and replacing the disposable litter pod by inserting a new litter pod.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific embodiment description or claim herein. This disclosure is intended to be read holistically such that any separable features or elements of the disclosure, in any of its aspects and embodiments, should be viewed as intended to be combinable, unless the context of the disclosure clearly dictates otherwise.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a litter pod system including a litter pod and a base in a decoupled configuration according to one embodiment of the present disclosure;

FIG. 2 illustrates a litter pod system including a litter pod and a base in a coupled configuration according to one embodiment of the present disclosure;

FIG. 3 illustrates an upper frame for use with a litter pod system according to one embodiment of the present disclosure;

FIG. 4 illustrates a litter pod system including a litter pod, a base, and an upper frame, and a cut away view of the connection between the upper frame and the base according to one embodiment of the present disclosure;

FIG. 5 illustrates a hood assembly for use with a litter pod system according to one embodiment of the present disclosure;

FIG. 6 illustrates a component view of a litter pod system including a litter pod, a removable cover, a base, an upper frame, and a hood assembly according to one embodiment of the present disclosure.

### DETAILED DESCRIPTION OF THE DISCLOSURE

The present disclosure now will be described more fully hereinafter with reference to specific embodiments and particularly to the various drawings provided herewith. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a,” “an,” “the,” include plural referents unless the context clearly dictates otherwise.

The present disclosure relates to litter pod systems having advanced performance characteristics, and methods of using such systems. Litter pod systems according to the present disclosure exhibit enhanced characteristics and functionalities that may include, but are not limited to, reduced sticking and clumping of the litter compositions, less tracking of litter compositions outside of the litter box system, odor reduction, easy and sanitary disposal, ease of cleaning, improved functional design, optional enhancement features, and the like. Litter pod systems of the present disclosure generally include a disposable litter pod (e.g., pre-filled with an animal litter composition) and a base unit configured to retain the disposable litter pod in a locked position during use.

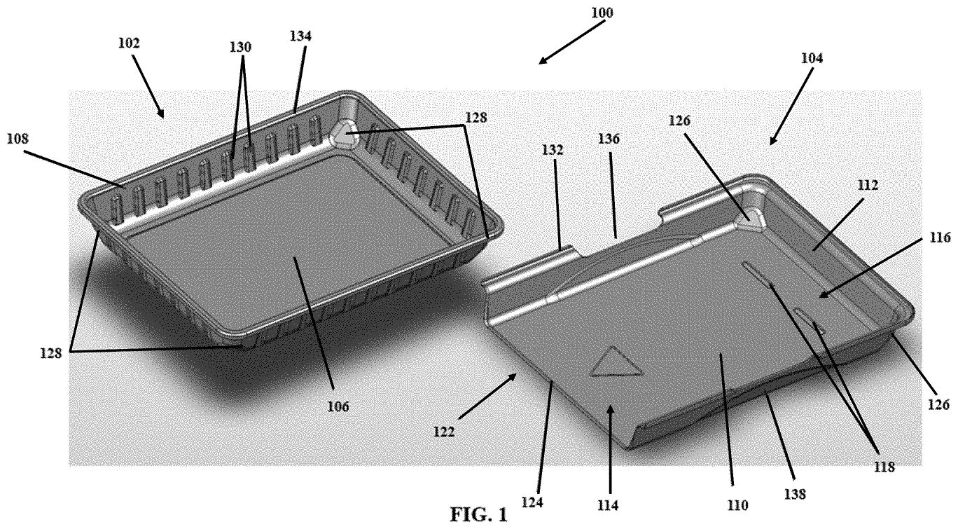

In some embodiments, litter pod systems according to the present disclosure may comprise a litter pod and a housing base. FIG. 1 illustrates one embodiment of a litter pod system as described herein wherein the litter pod system 100 is in a decoupled configuration with respect to the litter pod 102 and the housing base 104. For example, the litter pod system 100 depicted in FIG. 1 may comprise a litter pod 102 formed at least partially of flexible, polymer material that defines a substantially flat pod bottom wall 106 and a pod side wall 108 extending upward therefrom. As discussed herein below, in some embodiments, the litter pod may be formed of fiber-based material that has been at least partially coated with the flexible, polymer material. The litter pod system may further comprise a housing base 104 configured to receive the litter pod 102, the housing base 104 being formed of a substantially rigid polymer material defining a housing bottom wall 110 and a housing side wall 112 extending upward therefrom. Generally, the polymer materials forming at least a portion of the litter pod and the housing base may vary. Suitable flexible, polymer materials and substantially rigid polymer materials according to the present disclosure will be discussed further herein, but generally, the flexibility/rigidity of said polymer materials may depend on the thickness of the polymer material. As noted above, in some embodiments, the litter pod may be formed of a fiber-based material that has been at least partially coated with a flexible, polymer material. Suitable fiber-based materials according to the present disclosure will be discussed further herein, but generally, any fiber-based material formed of natural or synthetic fibers would be suitable. In some embodiments, both the pod side wall and the housing side wall may comprise a pair of longitudinal walls and a pair of transverse walls. In some embodiments, the longitudinal walls may have a length greater than, equal to, or less than the length of the transverse walls. Generally, the intersection of any longitudinal wall with any transverse wall and any bottom wall (e.g., either the pod bottom wall or the housing bottom wall) may form one or more right angles and this intersection point may be referred to herein as a “corner joint,” for example.

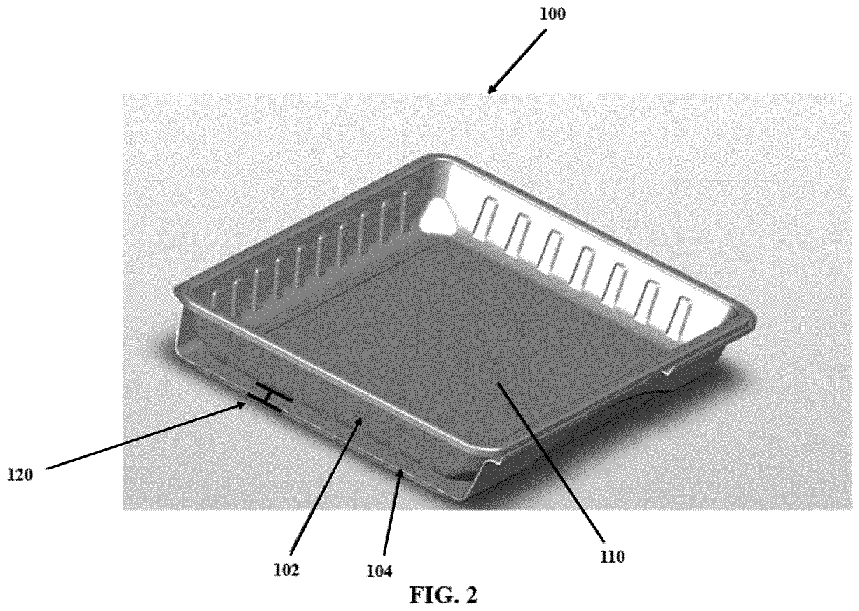

In some embodiments, the litter pod system may further comprise a gap 120 defining a clearance between the pod bottom wall 106 and the housing bottom wall 110, for example, as depicted in FIG. 2 when the litter pod 102 and the base 104 are in a coupled configuration. The degree of clearance between the pod bottom wall and the housing bottom wall may vary and generally may be measured in terms of the height of the gap. For example, the gap, and accordingly the defined height may be at least about 1/64 inch, at least about 1/32 inch, at least about 1/16 inch, or at least about ⅛ inches. In some embodiments, the defined height may be in the range of about 1/100 inch to about ½ inch, about 1/32 to about ¼ inch, or about 1/16 inch to about ⅛ inch. In some embodiments, the pod bottom wall may be thin and flexible (e.g., so as to allow for flexion of the pod bottom wall when the litter pod and the housing base are in a coupled configuration). By allowing flexion in the pod bottom wall of the litter pod, it is difficult for clumps of soiled litter composition to stick to the litter pod. Without intending to be bound by theory, it should be noted that when an animal enters the litter pod, such additional flexion of the pod bottom wall may prevent such clumps from sticking to the animal's feet, thus preventing the animal from tracking the litter composition outside of the litter box system. Alternatively, in some embodiments, the litter pod system may not comprise a gap when in a coupled configuration. In some embodiments, the litter pod may fit snugly within the housing base, e.g., such that the housing bottom wall is in direct contact with the pod bottom wall.

As used herein, a “coupled configuration” is meant to refer to a configuration wherein the litter pod has been inserted into the housing base to form a connection therebetween (e.g., as depicted in FIG. 2) such that substantial movement of the litter pod and the housing base will not occur, except as otherwise described herein. The specific mechanism for providing this coupled connection between a litter pod and a housing base according to the present disclosure may vary. For example, in some embodiments the connection may be in the form of a press-fit engagement, a snap-fit engagement, a magnetic engagement, a sliding arrangement, and any other locking-type mechanism that is configured to temporarily, releasably secure the litter pod and housing base prior to disposing of the litter pod. In some embodiments, the litter pod and the housing base may generally be in a sliding arrangement, e.g., where the housing base 104 is configured to receive the litter pod 102 by sliding the litter pod into the housing base to form a connection therebetween as depicted in FIG. 2. Various components of the litter pod system can facilitate such a connection (e.g., contribute to temporarily securing the litter pod and the housing base in a coupled configuration) and those components will be discussed herein with reference to FIG. 1 (i.e., showing a decoupled configuration) for visual purposes.

Referring back to FIG. 1, in some embodiments, one of the longitudinal walls or one of the transverse walls in the housing side wall 112 may be absent, e.g., forming an open face 122. In some embodiments, the open face may be positioned proximate to a first end 114 of the housing bottom wall. The open face 122 may be configured to receive the leading edge of the litter pod 102 therethrough, for example, such as inserting/sliding the litter pod into the housing base via the open face to form a litter pod system that is in a coupled configuration as described herein. In some embodiments, the housing side wall 112 may further comprise a tapered flange 132 extending outward from a top perimeter of the housing side wall. For example, in some embodiments, the tapered flange may extend outwardly and vertically from the housing side wall so as to create a sliding channel therein. In some embodiments, the tapered flange may have a cross-section that is substantially L-shaped or substantially J-shaped so as to provide this sliding channel. In some embodiments, the litter pod may further comprise a lip 134 positioned along the top perimeter of the pod side wall 108. The lip may be configured to extend horizontally outward from the top perimeter of the pod side wall. For example, in some embodiments, the lip 134 of the pod side wall may be configured specifically to fit within the sliding channel defined by the tapered flange 132. Advantageously, in such embodiments, the tapered flange is configured to receive the lip of the pod side wall in a sliding arrangement, e.g., allowing the litter pod to be inserted into the housing base by sliding the lip of the pod side wall along the channel defined by the tapered flange to form a connection therebetween. Such an embodiment particularly provides for a smooth, simple, and secure connection between the litter pod and the housing base.

In some embodiments, the tapered flange 132 may further comprise two cut outs 136 on opposing sides of the housing side wall 108. The size and shape of the cut outs may vary. Generally, the presence of the cut outs provides for a more ergonomic feel and increased comfort when grasping the base, for example, in some embodiments wherein the housing base comprises one or more gripping zones, as will be discussed further below, the cut outs may align with such gripping zones to increase comfort during use.

In some embodiments, the housing bottom wall may be defined by a first end 114, a second, opposing end 116, and a ridge 118 that protrudes out from the housing bottom wall. In some embodiments, such as the embodiment depicted in FIG. 1, the ridge may be positioned proximate the second, opposing end 116 of the housing bottom wall and opposite the first end 114. Such a configuration is provided as a mere example and should not be construed as limiting, for example, it is possible for the ridge to be positioned anywhere within the housing bottom wall. In some embodiments, the ridge may define a ridge height that is the same as the height defined by the gap 120 between the housing bottom wall and the pod bottom wall. For example, in some embodiments, the ridge is configured to abut (i.e., be in physical contact with) the pod bottom wall when the litter pod system is in a coupled configuration. Such a configuration may at least partially prevent movement of the litter pod and/or prevent the litter pod from sliding out of the housing base, e.g., by exerting a frictional force on the litter pod. In some embodiments, the ridge 118 may comprise a plurality of ridges, bumps, braces, and generally any type of protrusion capable of abutting the pod bottom wall. In some embodiments, one or more ridges may define a height that is greater than the height defined by the gap between the housing bottom wall and the pod bottom wall, for example, to secure the housing base to the litter pod when in a coupled configuration. In such an embodiment, the pod bottom wall may comprise one or more notches in the pod bottom wall configured to receive the one or more ridges to provide this secure arrangement.

In some embodiments, the housing bottom wall may further define an upwardly curved edge 124 positioned at the first end 114 of the housing bottom wall 110 and proximate to the open face 122. In some embodiments, the upwardly curved edge may protrude out from the first end of the housing bottom wall defining an edge height. In some embodiments, the edge height may vary. For example, in some embodiments, the edge may be the same as, or less than, the height defined by the gap between the housing bottom wall and the pod bottom wall. In some embodiments, the upwardly curved edge may be configured to abut the litter pod (e.g., similar to the ridge) or in certain embodiments, the upwardly curved edge may be offset from the litter pod, e.g., as depicted in FIG. 2. In embodiments such as the embodiment shown in FIG. 2, the offset nature of the upwardly curved edge may function to temporarily prevent the litter pod from sliding out of the housing base. As will be discussed below, the upwardly curved edge and the ridge may serve to facilitate efficient disposal of the litter pod from the litter pod system in response to a tilting action performed by a user of litter pod systems according to the present disclosure.

In some embodiments, the housing base and/or the litter pod may comprise one or more chamfers in the housing side wall and/or the pod side wall, respectively. As used herein, a “chamfer” is meant to be defined according to the typical use of the word chamfer with respect to mechanical designs. For example, a chamfer is typically defined in the art as a transitional edge between two faces of an object, e.g., sometimes referred to as a form of bevel, it is often created at a 45° angle between two adjoining right-angle faces. Chamfers are typically used in machining, carpentry, furniture, concrete formwork, mirrors, printed circuit boards, mechanical engineering designs, and the like. It should be noted that chamfers according to the present disclosure are not meant to be limited to having a 45° angle or any particular shape or size. The shape of the chamfers as described herein may vary in size, shape, and number; however, generally the shape of the housing chamfers and the pod chamfers are of substantially the same shape so as to facilitate engagement therebetween when the litter pod system is in a coupled configuration. For example, in some embodiments, the housing base and/or the litter pod may comprise at least 1 chamfer, at least 2 chamfers, at least 3 chamfers, or at least 4 chamfers. In some embodiments, the housing chamfers and/or pod chamfers may be substantially in the shape of a triangle. In some embodiments, the housing chamfers and/or the pod chamfers may create an angle between two adjoining right angle faces (e.g., at the “corner joint”) of the housing side wall and/or the pod side wall, respectively, that is about 15° to about 75°, 30° to about 60°, or about 40° to about 50°. It should also be noted that the chamfered corners of the litter pod make it difficult for used litter to accumulate and stick in the corners of the litter pod. Typical litter pods and litter boxes known in the art generally have radii corners that form a 90° angle in the corner of the pod. This particular design is susceptible to build-up of clumped litter in the corners of the pod which makes it difficult for a user to scoop these clumps out of the litter without the clumps falling apart and which can lead to a build-up of bacteria in these corners. The chamfered corners of litter pods according to the present disclosure advantageously reduce clumping of soiled litter in the corners of the litter pod and make it easier for a user to scoop soiled litter out of the litter pod.

In some embodiments, such as depicted in FIG. 1, the housing base may comprise two housing chamfers 126 positioned at opposing corner joints of the housing bottom wall 110 and the housing side wall 112. For example, as depicted in FIG. 1, the two housing chamfers may be positioned proximate to the second, opposing end 116 of the housing bottom wall. In some embodiments, the litter pod may comprise two or more pod chamfers positioned at opposing corner joints of the pod bottom wall and the pod side wall. In some embodiments, the housing chamfers may be configured to engage one or more of the litter pod chamfers to provide a secure fit of the litter pod into the housing base when the litter pod system is in a coupled configuration. Advantageously, in some embodiments, such as the depicted embodiment in FIG. 1, the litter pod may comprise four pod chamfers 128 positioned at each of the four corner joints of the pod bottom wall and the pod side wall. Such a configuration allows the litter pod to be reversible, e.g., such that the litter pod can be inserted into the housing base from either a front end or a back end. In some embodiments (e.g., wherein the housing base does not comprise an open face 122), the housing base may also comprise four housing chamfers. In such an embodiment, the litter pod may be placed into the housing base and all four chamfers in both the housing base and the litter pod engage to provide a secure fit.

In some embodiments, the pod side wall may further define a plurality of ribs 130. For example, as depicted in FIG. 1, the plurality of ribs 130 may protrude out from the pod side wall 108 toward the interior of the lifter pod. In some embodiments, the ribs may be in the form of a plurality of indentations on the interior surface of the pod side wall, a plurality of ridges extending outwardly from the pod side wall, and/or a plurality of bumps positioned on the interior surface of the pod side wall. The size and shape of the ribs may vary. For example, in some embodiments, the ribs may be substantially rectangular shaped, substantially square shaped, substantially oval shaped, or substantially in the shape of any other regular or irregular polygon. It should be noted that the ribs defined by the side wall advantageously reduce clumping and/or sticking of soiled litter to the surfaces of the litter pod.

In some embodiments, the housing side wall 112 may further comprise one or more gripping zones 138 on the exterior surface of the housing side wall. The gripping zones may be designed to allow a user to grip the housing base more securely when using the litter pod system and when disposing of the litter pod. The size, shape, and number of gripping zones may vary. Generally, the presence of the gripping zones provides for a more ergonomic feel and increased comfort when grasping the housing base.

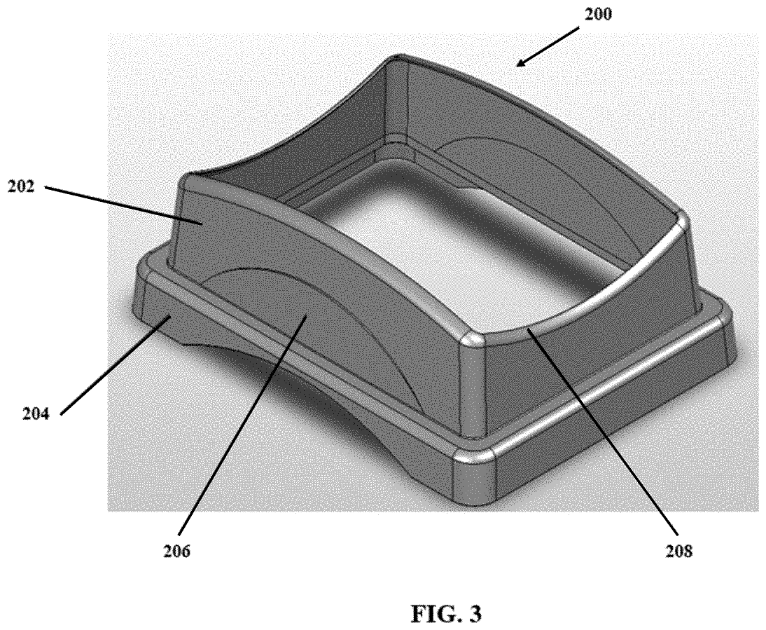

In some embodiments, litter pod systems according to the present disclosure may further comprise one or both of an upper frame and/or a hood assembly. For example, FIG. 3 depicts an upper frame 200 according to one embodiment of the disclosure. In some embodiments, the upper frame 200 may define an outer wall 202 and a skirt portion 204 configured to cover at least a portion of the housing side wall when the upper frame is in direct connection with a housing base. The height of the outer wall may vary and typically can be optimized in order to reduce the likelihood of litter escape and tracking of litter typically caused by an animal's movements within the litter pod, e.g., when the animal kicks its feet upon use the litter composition can be “kicked out” of the litter pod system. In some embodiments, the height of the outer wall of the upper frame may be in the range of about 4 inches to about 10 inches, or about 6 inches to about 8 inches. It should be noted generally that the height of the outer wall may be adjusted by a person having skill in the art based on the desired characteristics (e.g., reduced litter escape or “kicking out” by the animal), size of the animal designed to use the litter pod system, and the like. For example, as the height of the outer wall increases, generally the amount of litter escape or kick out is reduced. However, it is desirable not to increase the height of the outer wall past a point of animal dissatisfaction, which may vary depending on the size of the animal. As noted above, the skirt portion of the upper frame may be configured to cover at least a portion of the housing side wall so as to provide a secure connection between the housing base and the upper frame and also to prevent leakage of the litter composition from the litter pod during use. In some embodiments, the skirt portion may extend at least about ⅛ inches past the tapered flange of the housing side wall. In some embodiments, the skirt portion may extend at least about ⅛ inch, at least about ¼ inch, at least about ½ inch, at least about ¾ inch, at least about 1 inch, or at least about 2 inches past the tapered flange of the housing side wall.

In some embodiments, the upper frame may further comprise one or more gripping zones 206 on the exterior surface of the outer wall 202. The gripping zones may be designed to allow a user to grip the upper frame more securely when using the litter pod system. The size, shape, and number of gripping zones may vary. Generally, the presence of the gripping zones provides for a more ergonomic feel and increased comfort when grasping the upper frame.

In some embodiments, a top perimeter of the outer wall 202 may define an inwardly curved edge 208. In some embodiments, the inwardly curved edge may be in the form of a tapered flange or a bent edge. Particularly, it should be noted that the inwardly curved edge can effectively reduce the likelihood of litter escape and tracking of litter typically caused by an animal's movements within the litter pod or when the animal tracks the litter composition out of the litter box, e.g., such as litter stuck to the animal's paws or legs. For example, in some embodiments, the inwardly curved edge may function to deflect litter (or dust created from the litter composition) back down into the litter pod when compared to a non-curved frame that permits litter to escape from the litter pod more easily. In some embodiments, the inwardly curved edge may essentially serve as a brush or a scraper, e.g., such that it removes litter from an animal's paws and/or legs upon brushing against the inwardly curved edge when exiting the litter pod, thus preventing tracking.

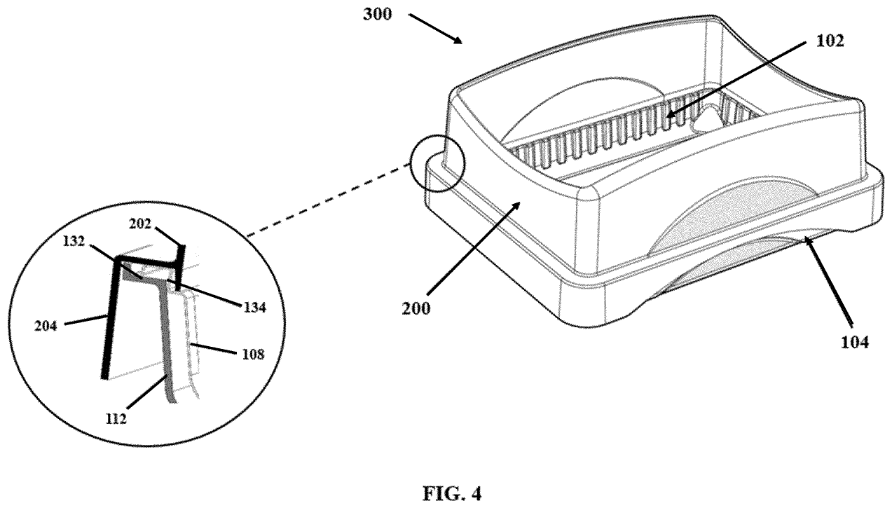

In some embodiments, litter pod systems may incorporate an upper frame in direct connection with a litter pod and a housing base. For example, FIG. 4 depicts a litter pod system 300 comprising a litter pod 102 (as depicted in FIG. 1), a housing base 104 (as depicted in FIG. 1), and an upper frame 200 (as depicted in FIG. 3). As shown in the cut away view in FIG. 4, the upper frame (via the outer wall 202 and the skirt portion 204) can be in direct connection with the tapered flange 132 of the housing base and the lip 134 of the litter pod. Such a configuration advantageously provides a secure fit of all three components (e.g., the housing base, the litter pod, and the upper frame) of the litter pod system and further prevents leakage of the litter compositions in the litter pod during use of the litter pod system.

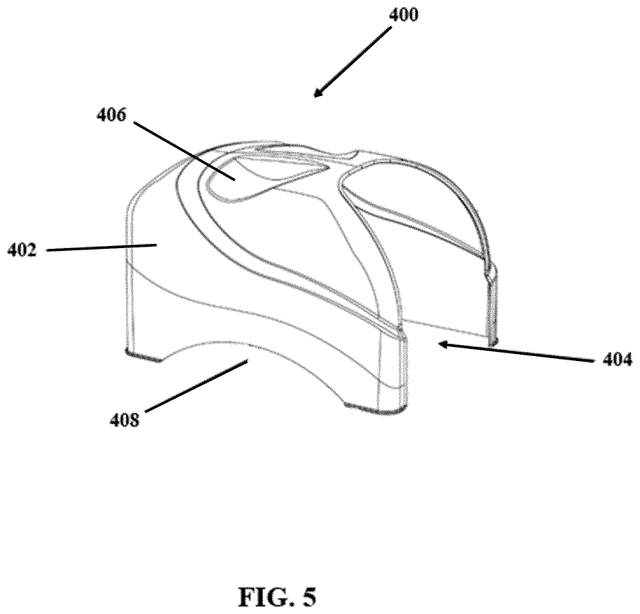

As noted above, litter pod systems according to the present disclosure may further comprise a hood assembly. For example, FIG. 5 depicts a hood assembly 400 according to one embodiment of the present disclosure. In some embodiments, the hood assembly 400 may comprise an outer shell 402 with at least one opening defining an animal entry-way 404. In such embodiments, the area of the animal entry-way and the volume defined under the hood assembly can be large enough to accommodate animals of varying sizes. For example, the size the hood assembly may vary based on the particular use and/or the size of the animal. In some embodiments, the hood assembly may further comprise one or more vents 406 defined by one or more openings in the outer shell. In some embodiments, the vents may be configured for passive release of odor from the litter pod system and/or to prevent accumulation of moisture within the litter pod system generally. In some embodiments, the hood assembly may provide a variety of advantageous features, for example, providing animal security, providing isolation and further containment of the litter composition, and/or preventing excess litter scattering or escape during use.

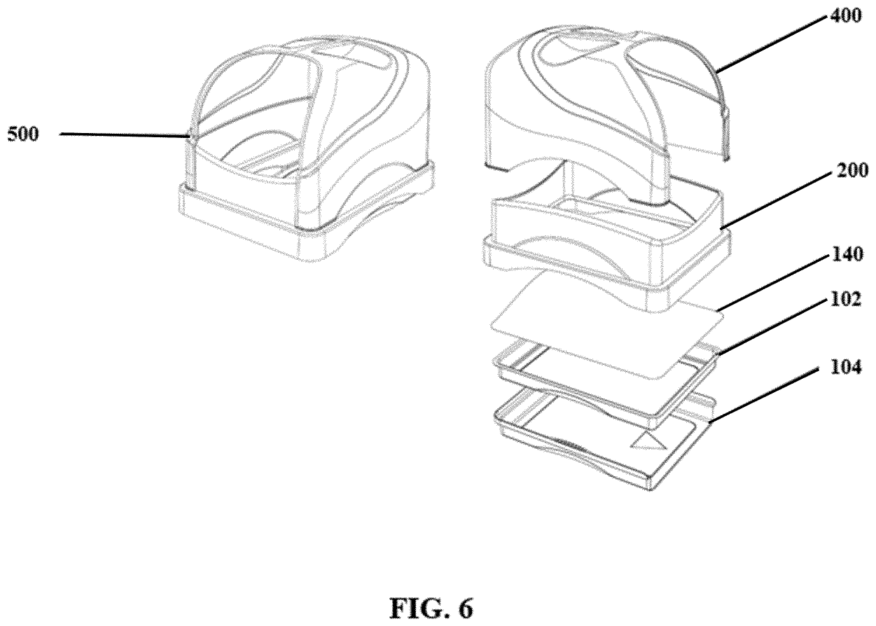

As noted above, litter pod systems may incorporate a hood assembly in direct connection with a litter pod and a housing base or, separately, in direct connection with an upper frame. In some embodiments, for example, the hood assembly may comprise a flat bottom edge (not pictured) that directly connects to the lip of the litter pod and/or the tapered flange of the housing base. In other embodiments, the hood assembly may comprise a formed edge 408 that is molded to fit snugly with the shape of the upper frame when directly connected (e.g., such that this formed edge does not cover the gripping zones on the upper frame). FIG. 6, for example, depicts a litter pod system 500 comprising a housing base 104 (as depicted in FIG. 1), a litter pod 102 (as depicted in FIG. 1), an upper frame 200 (as depicted in FIG. 3), and a hood assembly 400 (as depicted in FIG. 5). In the depicted embodiment, the hood assembly is in direct connection with the upper frame, e.g., such that a combination of the upper frame and the hood assembly are secured to the housing base and the litter pod in one singular assembly. In some embodiments, the hood assembly may be provided without the upper frame, for example, the hood assembly may be in direct connection with the housing base and the litter pod.

As noted above, litter pods as described herein may be disposable and/or replaceable. In some embodiments, disposable/replaceable litter pods as described herein may comprise a removable cover 140 (e.g., as depicted in FIG. 6) configured to seal the litter pod along a top perimeter of the pod bottom wall prior to removal of the cover for use. The cover may comprise any type of material capable of sealing the litter pod to prevent leaking of the litter composition from the litter pod or to prevent infiltration of moisture or other outside contaminants into the litter composition.

### Methods of Using Litter Pod Systems

The present disclosure provides for methods of assembling litter pod systems and methods of using litter pod systems, generally. For example, in some embodiments, the present disclosure provides a method of assembling a litter pod system, the method comprising providing a housing base, an upper frame, and a disposable litter pod pre-filled with animal litter, the housing base being configured to receive the disposable litter pod; inserting the disposable litter pod into the housing base such that the disposable litter pod is releasably secured by the housing base in a coupled configuration; positioning the upper frame overtop the housing base and the disposable litter pod while in a coupled configuration; and applying pressure to the upper frame to secure the upper frame to the housing base. Referring back to FIG. 1, in some embodiments, the disposable litter pod may be inserted into the housing base by sliding the litter pod into the open face of the housing base (e.g., by aligning the lip 134 of the housing base with sliding channel defined by the tapered flange 132). As noted above, upon inserting the litter pod into the housing base the litter pod may optionally be held in place by one or both of the ridge 118 in the housing bottom wall and/or the upwardly curved edge 124 in the housing bottom wall positioned proximate to the open face. Once the litter pod is secured in place, the litter pod system is in a coupled configuration as depicted in FIG. 2. In some embodiments, the method may optionally comprise providing a hood assembly configured to be secured to the upper frame or directly to the housing base.

In some embodiments, the present disclosure provides “no-mess” methods of disposing of animal litter from a litter pod system, e.g., wherein a user advantageously does not have to come into physical contact with the soiled litter compositions contained within the disposable litter pod. In some embodiments, the disclosed disposal methods may comprise providing a housing base configured to receive a disposable litter pod; inserting a disposable litter pod in the housing base to form a litter pod system; lifting the litter pod system and tilting the housing base toward a disposal area such that the litter pod is deposited in the disposal area; and replacing the disposable litter pod by inserting a new litter pod. As noted above, once the disposable litter pod is inserted into the housing base, the litter pod is in a coupled configuration and may optionally be further secured in place by physical contact with the ridge and/or the upwardly curved edge of the housing base. Such a configuration prevents significant movement of the litter pod when a user picks up the litter pod system (i.e., for movement to a particular location or to a disposal area). When a user desires to dispose of a litter pod from the litter pod system (e.g., when the litter composition becomes soiled to the degree in which it needs to be replaced), he or she can easily disrupt this coupled configuration between the litter pod and the housing base by lifting the litter pod system and tilting the housing base at an angle toward the disposal area. Such an action by the user (referred to herein as the “disposal action”) releases the litter pod from its coupled configuration so that the litter pod is allowed to slide out from the sliding channel in the housing base (i.e., created by the tapered flange 132 as depicted in FIG. 1) when a user of the litter pod system tilts the housing base toward the disposal area. Thus, this disposal method requires no contact between the user and the disposable litter pod. In some embodiments, one or more additional bumps or ridges may be provided in the housing base and may be configured to further limit the sliding action of the litter pod so as to control the pod release when the disposal action is performed by the user. Without intending to be bound by theory, it should be noted that friction between the one or more bumps and/or ridges in the housing base and the litter pod generally keeps the pod secured in place until an appropriate angle is achieved during the disposal action by the user such that the gravitational force on the litter pod is greater than the frictional force holding the litter pod in place, thus allowing the pod to slide out of the housing base and into the disposal area.

The disposal methods of the present disclosure are particularly advantageous in that the pre-filled litter pods do not require any pouring of litter compositions into the litter pod system (e.g., reducing odor, dust generation, and spillage typically experienced with other litter boxes) and the disposal action is fast, secure, and provides no-mess disposal (e.g., litter pod system remains in a coupled configuration until a user tilts the housing base to allow the litter pod to slide out). This disposal action prevents the user from having to touch the litter composition and also prevents any aeration of the litter typically caused by dumping the litter composition in the disposal area. Further, the weight of the litter pod is supported by the housing base of the litter pod system prior to performing this disposal action which minimizes spillage of the litter composition from the litter pod during disposal. Advantageously, the disposal processes according to the present disclosure may reduce the length of time required by the user to properly dispose of the litter pod when compared to standard methods of disposing of litter compositions.

### Materials

The litter pod systems of the present disclosure and components thereof may be formed of various different types of materials. For example, housing bases, litter pods, upper frames, and/or hood assemblies as described herein may be formed of one or more different materials and/or combinations thereof. Suitable materials for various components within the litter pod systems of the present disclosure may include, but are not limited to various polymer materials, thermoplastic materials, heavy duty plastics, and/or fiber-based materials (e.g., paper or paperboard materials, including pulps). Example polymer materials for forming one or more components of the litter pod system may include, but are not limited to: polyethylene terephthalate (PET), polytetrafluoroethylene (PTFE), high-density polyethylene (HDPE), low-density polyethylene (LDPE), polyvinyl chloride (PVC), polypropylene (PP), polystyrene (PS), polyethylene (PE), acrylonitrile butadiene styrene (ABS), and the like. It should be noted that the types of polymer materials discussed herein are not meant to be limiting and that the particular types of materials used may be varied as necessary to impart the desired physical characteristics on one or more components of the litter pod system formed from those materials.

Example fiber-based materials used for forming one or more components of the litter pod system may include, but are not limited to: materials formed of cellulose-based fibers (e.g., such as viscose fibers, conventional cellulose fibers, regenerated cellulose fibers, hardwood pulps, softwood pulps, and the like), cotton fibers, wool fibers, hemp fibers, other plant-based sources (e.g., such as sugarcane, bagasse, bamboo, and the like), polymer-based fibers, other synthetic fibers, and combinations thereof. In some embodiments, one or more components of the litter pod system (the disposable litter pod, in particular) may be formed of a recyclable fiber-based material such as paper or paperboard formed using any type of fiber material as described herein. In such embodiments, at least a portion of the fiber-based material may be at least partially coated with a polymer material and/or other coating as described herein, for example, to increase durability and/or to prevent liquid permeation therethrough and/or to increase the surface energy thereof.

As noted herein, the housing base, and optionally the upper frame and the hood assembly, are generally formed of a substantially rigid polymer material. The rigidity of a polymer material, and likewise the rigidity of components of the litter pod system formed from that polymer material, are generally controlled by altering the thickness of the polymer material used. As used herein, a “substantially rigid polymer material” refers to a polymer material having a thickness in the range of about 1.25 mm to about 5.0 mm. In some embodiments, the substantially rigid polymer material may have a thickness, for example, in the range of about 1.25 mm to about 5.0 mm, about 1.5 mm to about 4.0 mm, or about 2.0 mm to about 3.0 mm. Generally, a polymer material having a thickness in the range of about 1.25 mm to about 5.0 mm provides sufficient rigidity and hardness such that the polymer material is durable and non-deformable. Use of polymer materials having the desired rigidity is particularly beneficial to providing an overall litter pod system that is sturdy and durable over time.

As noted above, in one or more embodiments the disposable litter pod may be formed at least partially of a flexible, polymer material. In certain embodiments, for example, the disposable litter pod may be formed entirely of the flexible, polymer material. However, in certain other embodiments, the disposable litter pod may be formed of a different material than the other components of the litter pod system (e.g., the housing base, the upper frame, and the hood assembly). In such embodiments, the disposable litter pod may be formed of a fiber-based material (e.g., such as paper or paperboard and/or pulps). In some embodiments, the fiber-based material can be formed as reel of paperboard having a thickness in the range of about 0.01 inches to about 0.04 inches, about 0.015 inches to about 0.035 inches, or about 0.02 inches to about 0.03 inches. In other embodiments, the fiber-based material can be molded directly or indirectly. Indirect molding, for example, can utilize a pre-formed paper or paperboard that is processed to the desired shape in one or more molds. Direct molding, for example, may use a wet or “green” paper or pulp material that is placed into one or more molds and dried to the desired shape. Pulp molding likewise may be utilized wherein a pulp slurry is added to a one-part or two-part mold wherein pressure and/or vacuum may be applied to remove water and achieve the desired form. Suitable molding techniques, formulations, and components are described, for example in Mohan, Packaging World (Jan. 30, 2014); Bouckley, BeverageDaily.com (Mar. 10, 2014); Bouckley, BeverageDaily.com (Jan. 28, 2015); Pierce, Packaging Digest (May 20, 2015); and U.S. Pat. No. 7,048,975 to Tojo et al., the disclosures of which are incorporated herein by reference.

In one or more embodiments, the fiber-based material is at least partially coated with a flexible, polymer material as described herein. For example, in some embodiments, the disposable litter pod may be formed of a fiber-based material (e.g., such as paper or paperboard) that is extrusion coated with a polymer coating (e.g., such as PET) that is applied at an elevated temperature. In such embodiments, for example, the PET coating may be applied to an inner surface of the fiber-based material at a temperature of at least about 450° F., at least about 500° F., at least about 550° F., or at least about 600° F. In such embodiments, the extrusion polymer coating may provide a liquid resistant surface with low permeability. In addition, as noted above, the extrusion polymer coating may provide increased durability when compared to the underlying fiber-based material which can prevent scratching or tearing of the fiber-based material. For example, as discussed below, addition of the flexible, polymer coating may increase the Shore D hardness of the litter pod and/or the contact angle of the litter pod, in particular.

Irrespective of the particular construction of the disposable litter pod, the disposable litter pod may be referred to as being thin-walled and flexible. The flexibility of the disposable litter pod, and likewise the flexibility of components of the litter pod system using a polymer material or polymer coating, are generally affected by the thickness of that polymer material or polymer coating. As used herein, a “flexible, polymer material” refers to a polymer material or polymer coating having a thickness in the range of about 0.01 mm to about 1.0 mm. In some embodiments, the flexible polymer material or polymer coating may have a thickness, for example, in the range of about 0.01 mm to about 1.0 mm, about 0.025 mm to about 0.8 mm, or about 0.05 mm to about 0.6 mm. Generally, a polymer material or polymer coating having a thickness in the range of about 0.01 mm to about 1.0 mm provides the desired degree of flexibility while also maintaining pod strength and durability within the litter pod system. In some embodiments, the disposable litter pod may be in the form of a polymer bag. Example polymer bags may be formed using various types of polymer materials, for example, polyethylene or polypropylene. In some embodiments, the flexible, polymer material may be a material that is generally known to be recyclable.

In some embodiments, for example, one or more components of the litter pod system may be formed of, or coated with, at least partially, a polymer material characterized as having a very smooth surface with a high surface energy. It should be noted that the surface energy of a polymer material or polymer coating is commonly defined in relation to the contact angle of that polymer material. In particular, the contact angle of polymer material can quantify the wettability of the polymer surface by a liquid. Contact angle of a polymer material or polymer coating as used herein can be measured using ASTM D7334 (Standard Practice for Surface Wettability of Coatings, Substrates, and Pigments by Advancing Contact Angle Measurement), for example. Generally, a polymer material or polymer coating having a higher contact angle (e.g., greater than 70) is considered to be hydrophobic or having a higher surface energy, wherein a polymer material or polymer coating having a lower contact angle (e.g., less than 70) is considered to be hydrophilic or having a lower surface energy. As used herein, a “high surface energy material” is meant to refer to a polymer material and/or a composite polymer material and/or a polymer or composite polymer coating having a contact angle of at least about 70. In some embodiments, for example, one or more components of the litter pod system may comprise a polymer material or be coated with a polymer material having a contact angle of at least about 70, at least about 80, at least about 90, at least about 100, at least about 110, or at least about 120. In some embodiments, one or more components of the litter pod system may comprise a polymer material or be at least partially coated with a polymer material having a contact angle in the range of about 70 to about 130, about 80 to about 120, or about 90 to about 110.

Likewise, in some embodiments, the surface energy of a polymer material or a polymer coating as defined herein may be defined in terms of a particular unit (e.g., such as “Dynes per centimeter” or “Dynes/cm”). In such embodiments, a high surface energy polymer material or polymer coating may have a surface energy in the range of about 25 Dynes/cm to about 100 Dynes/cm, about 30 Dynes/cm to about 75 Dynes/cm, or about 40 Dynes/cm to about 60 Dynes/cm. In some embodiments, a high surface energy polymer material or polymer coating may have a surface energy of at least about 30 Dynes/cm, at least about 40 Dynes/cm, at least about 50 Dynes/cm, or at least about 60 Dynes/cm. Such high surface energy polymer materials or polymer coatings as defined herein may advantageously be resistant to scratching such that the one or more components retain a substantially smooth surface during use. Without intending to be bound by theory, it should also be noted that the high surface energy materials prevent sticking of bacteria and/or clumps of soiled litter compositions to the sides of the litter pod, thus reducing odor build and growth of bacteria within the litter pod system.

In some embodiments, one or more components of the litter pod system may also be formed of a material having a high polymer hardness, for example, the material may comprise one or more polymer materials or polymer coatings with a high polymer hardness. It should be noted that the hardness of a material is commonly defined in relation to the Shore D Hardness of that material, which can be measured using a Shore durometer, for example. Shore D Hardness of a polymer material can be measured using ASTM D2240 (Standard Test for Hardness and Elastic Modulus). Generally, a polymer material or polymer coating having a higher Shore D Hardness can provide increased scratch-resistance and/or be resistant to deformation. Materials having a “high polymer hardness” as used herein, refer to polymer materials or polymer coatings having a Shore D Hardness of at least about 50. In some embodiments, for example, one or more components of the litter pod system may comprise a polymer material or polymer coating having a Shore D Hardness of at least about 50, at least about 60, at least about 70, at least about 80, or at least about 90. In some embodiments, one or more components of the litter pod system may comprise a polymer material or polymer coating having a Shore D Hardness in the range of about 50 to about 120, about 60 to about 110, or about 70 to about 100. Typical litter pods and litter boxes are generally susceptible to scratching from a cat's claws, plastic or metal scoops used to scoop out the litter compositions, and general wear and tear of the product. Such scratching on the surface of litter pods can generally cause bacterial growth, and thus odor production, within the litter pod system over time. However, use of polymer materials and/or polymer coatings having a high polymer hardness in forming various components of the litter pod system can advantageously prevent such scratching on the surface of those components. As such, the litter pod systems and components described herein, being formed of a polymer material or having a polymer coating having a Shore D Hardness of at least about 50, may generally be referred to as being scratch-proof and/or scratch-resistant.

In some embodiments, the materials used for forming various components of the litter pod system of the present disclosure may further comprise one or more additives or surface coatings, in addition to the underlying polymer material or polymer coating applied thereto, capable of altering one or more characteristics of the overall material (e.g., increasing the surface energy and/or the polymer hardness). As noted above, increasing the surface energy and/or the polymer hardness of these components may advantageously provide scratch and/or odor prevention or resistance. Examples of surface coatings and additives that may be applied to one or more components of the litter pod systems described herein may include, but are not limited to, silicon, Teflon, various high energy polymer materials, hydrophobic coatings, moisture resistant inks or colorants, and the like.

In certain embodiments, for example, an inner surface of the disposable litter pod may be extrusion coated with a flexible, polymer coating as described herein and an outer surface of the disposable litter pod may be treated with a surface coating comprising one or more moisture resistant materials. For example, in some embodiments, the outer surface of the fiber-based disposable litter pod may be coated with a solution containing moisture resistant materials (e.g., such as ammonium hydroxide and diethylene glycol monoethyl ether) that provide resistance to liquid permeation through the disposable litter pod. It should be noted that the surface coating may be applied as a single coating or in multiple coatings. In some embodiments, the underlying fiber-based material in the disposable litter pod may be printed with a moisture resistant ink, a moisture lock out ink, and/or colorant to provide the desired design attributes thereon.

Without intending to be bound by theory, it should be noted that the flexibility and/or rigidity of one or more components of the litter pod system may be varied via one or more different parameters, e.g., in addition to altering the thickness of the polymer material or the polymer coating, by altering the types of polymer materials used and/or by altering the individual properties of the materials used in one or more components of the liter pod system (e.g., Shore D Hardness, contact angle, etc.). Thus, the flexibility/rigidity of the flexible, polymer material and the substantially rigid polymer material may vary in some embodiments and can be adjusted as desired, as noted herein above.

### Litter Compositions

Advantageously, the litter pods described herein may be pre-filled with litter compositions to avoid the mess of scooping litter compositions into the litter pods or pouring such compositions into the litter pod. Litter compositions are generally known, for example, to generate dust when poured into conventional litter boxes or trays. Thus, providing pre-filled litter pods as described herein can advantageously prevent spilling and or excess dust generation associated with filling conventional litter boxes. Various types of animal litters and litter compositions may be used with the litter pod systems and methods disclosed herein and the types of litter compositions described herein are not to be construed as limiting with respect to the particular type of litter composition used. Types of animal litter compositions may vary and are generally known in the art. For example, suitable types of animal litter compositions may include, but are not limited to: litters made from clay-based materials, silica-based materials, recycled paper, pine-based materials, corn-based materials, wheat-based materials, crushed or pulverized walnut shells, grass-based materials, and the like. Generally, litter compositions may be provided in the form of clumping and non-clumping litter compositions.

In some embodiments, a clay-based animal litter may be used in the pre-filled litter pods of the present disclosure. Clay-based litter compositions can comprise, for example, at least a clay-based liquid absorbing material, one or more fillers, and one or more optional ingredients. A clay based liquid-absorbing material for use in an animal litter composition as described herein can include any such material previously recognized as useful in forming animal litters. In some embodiments, the clay-based liquid absorbing material is a naturally clumping clay. For example, a clay soil or comminuted rock containing at least one water swellable clay mineral (such as a montmorillonoid or smectite) can be used. More particularly, a comminuted bentonite, more preferably a sodium bentonite, which contains a preponderant amount of montmorillonite clay mineral, may be used as the clay-based liquid absorbing material in the present animal litter composition. Non-limiting examples of bentonite clays that can be used include sodium bentonite, potassium bentonite, lithium bentonite, calcium bentonite and magnesium bentonite, or combinations thereof. Clay-based liquid absorbing materials are described, for example, in U.S. Pat. No. 8,720,375 to Miller et al., the disclosure of which is incorporated herein by reference.

In one or more embodiments, the performance of the present animal litter composition can relate to one or more properties of the clay-based material apart from its ability to absorb liquid. In some embodiments, performance can be improved though use of a clay-based material exhibiting a defined particle size range. For example, suitable clay-based materials can be provided with an average particle size of about 0.2 mm to about 5 mm, about 0.3 mm to about 4 mm, or about 0.5 mm to about 3 mm. In some embodiments, the surface area of each particle of the clay-based material may comprise a defined surface area that that has been found to maximize effectiveness of the animal litter composition in exhibiting reduced adhesion to surfaces when the litter is wetted. For example, particles of the clay-based material can have an average surface area that is less than 20 m²/g, less than 15 m²/g, or less than 10 m²/g. In each of the foregoing ranges, it is understood that the particles preferably have a minimum surface area of at least 1 m²/g. In some embodiments, the particles of the clay-based material can have an average surface of about 1 m²/g to about 20 m²/g, about 2 m²/g to about 15 m²/g, or about 3 m²/g to about 10 m²/g. Surface area can be measured utilizing known methods, such as the Brunauer, Emmett, Teller (“BET”) method wherein surface area is calculated using N₂ absorption. The above values, in some embodiments, thus may be referred to as the BET surface area.

The amount of the clay-based liquid absorbing material used in the present animal litter composition can vary. For example, the clay-based liquid absorbing material can form about 15% by weight to about 99.5% by weight of the composition. In further embodiments, the amount of the clay-based liquid absorbing material in the animal litter composition can be about 20% by weight to about 94% by weight, about 25% by weight to about 90% by weight, about 30% by weight to about 80% by weight, or about 35% by weight to about 55% by weight based on the total weight of the composition.

Fillers suitable for use in the present animal litter compositions can include a variety of materials that can be a non-absorbent, non-soluble substrate, or can be an absorbent substrate. In one or more embodiments, useful fillers can include absorbent substrates, such as non-clumping clays. Non-limiting examples of useful non-clumping clays include attapulgite, Fuller's earth, calcium bentonite, palygorskite, sepiolite, kaolinite, illite, halloysite, hormite, vermiculite or mixtures thereof. Suitable fillers according to the present disclosure also can include a variety of non-absorbent, non-soluble substrates, such as non-clay substances. Non-limiting examples of non-clay materials that can be used include zeolites, crushed stone (e.g., dolomite and limestone), gypsum, sand, calcite, recycled waste materials, and silica.

In some embodiments, it can be useful to provide the filler material in a form exhibiting specific characteristics. For example, it can be useful for the filler material to exhibit an average particle size that is approximately the same as the clay-based liquid absorbing material particles. In particular, the filler material may exhibit an average particle size that is +/−20%, +/−15%, +/−10%, or +/−5% of the average particle size of the clay-based liquid absorbing material particle size. In some embodiments, it likewise can be useful for the filler material to have an average surface area that is approximately the same as the surface area of the clay-based liquid absorbing material particles. The above tolerances thus likewise can apply to surface area.

The amount of the filler used in the present animal litter composition can vary. In some embodiments, filler may be expressly excluded (i.e., forming 0% of the litter composition). Preferably, the filler provides the balance of the animal litter composition after all other materials are included. As examples, the animal litter composition can comprise about 0% by weight to about 75% by weight, about 10% by weight to about 70% by weight, about 25% by weight to about 65% by weight, or about 40% by weight to about 60% by weight of the filler based on the total weight of the animal litter composition.

In some embodiments, the animal litter composition may also include one or more clumping agents, or clump enhancing materials. Description of suitable clumping agents is provided in U.S. Pat. No. 8,720,375 to Miller et al., the disclosure of which is incorporated herein by reference. Useful clumping agents are those materials suitable to promote adhesion of the fine size particles of litter granules to each other as well as adhesion of the particles to form agglomerates when wetted. Preferably, the clumping agent allows the formation of a gelled agglomerate when exposed to a liquid, such as animal urine. A clumping agent may be provided in admixture (e.g., in particle form) with the further particles forming the animal litter. In some embodiments, the clumping agent can be provided as a coating on at least a portion of the other particles forming the animal lifter (e.g., as a coating on at least a portion of the filler material). Such coatings may be provided by any known method, such as spraying.

Non-limiting examples of materials suitable for use as a clumping agent include naturally occurring polymers (e.g., naturally occurring starches, water soluble polysaccharides, and gums), semisynthetic polymers (e.g., cellulose derivatives, such as carboxymethyl cellulose), and sealants. Exemplary clumping agents include amylopectins, natural gums, and sodium carboxymethylcellulose. The amount of any clumping agent that is present in the animal litter composition can vary based upon the total composition. For example, it can be useful to include a greater amount of clumping agents when a greater amount of non-absorbent fillers is used. In some embodiments, clumping agents can be present in a total amount of 0.1% by weight to about 6% by weight, about 0.2% by weight to about 5.5% by weight, about 0.3% by weight to about 5% by weight, or about 0.5% by weight to about 4% by weight.

In addition to the foregoing, one or more further materials may be included in the present animal litter composition. Specifically, any conventional litter additive may be included to the extent that there is no interference with the ability of the litter composition to provide the useful effect of reduced adherence to surfaces when wetted. Non-limiting examples of additional materials that may be used include binders, preservatives, such as biocides (e.g., benzisothiazolinone, methylisothiazolone), de-dusting agents, fragrance, bicarbonates, and combinations thereof. Each of the foregoing materials separately may be included in any amount up to about 5% by weight, up to about 2% by weight, up to about 1% by weight, or up to about 0.5% by weight, such as about 0.01% by weight to about 5% by weight, to about 4% by weight, to about 3% by weight, to about 2% by weight, or to about 1% by weight based on the total weight of the animal litter composition. Further, it is understood that any one or more of such materials may be expressly excluded from the present animal litter composition.

Many modifications and other embodiments of the disclosure set forth herein will come to mind to one skilled in the art to which these disclosures pertain having the benefit of the teachings presented in the foregoing descriptions. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A litter pod system, comprising:
a litter pod formed at least partially of a flexible, polymer material, the litter pod defining a substantially flat pod bottom wall with a pod side wall extending upward therefrom;
a housing base configured to receive the litter pod, the housing base being formed of a substantially rigid polymer material defining a housing bottom wall with a housing side wall extending upwardly therefrom.

2. The litter pod system of claim 1, further comprising a gap defining a clearance between the pod bottom wall and the housing bottom wall.

3. The litter pod system of claim 1, wherein the pod side wall and the housing side wall both comprise a pair of longitudinal walls and a pair of transverse walls.

4. The litter pod system of claim 3, wherein one of the longitudinal walls or one of the transverse walls forming the housing side wall is absent so as to define an open face.

5. The litter pod system of claim 4, wherein the housing bottom wall defines an upwardly curved edge proximate to the open face.

6. The litter pod system of claim 1, wherein the housing base further comprises two or more housing chamfers positioned at opposing corner joints of the housing bottom wall and the housing side wall.

7. The litter pod system of claim 6, wherein the litter pod further comprises two or more pod chamfers positioned at opposing corner joints of the pod bottom wall and the pod side wall.

8. The litter pod system of claim 7, wherein the housing chamfers and the pod chamfers are substantially triangular in shape.

9. The litter pod system of claim 7, wherein the housing chamfers and the litter pod chamfers are configured for engagement therebetween.

10. The litter pod of claim 1, wherein the pod side wall defines a plurality of ribs that protrude from the pod side wall toward an interior of the litter pod.

11. The litter pod system of claim 1, wherein the housing base further comprises a ridge that protrudes out of the housing bottom wall, the ridge being configured to abut the pod bottom wall.

12. The litter pod system of claim 11, wherein the ridge comprises a plurality of ridges or bumps.

13. The litter pod system of claim 1, wherein the housing side wall comprises one or more gripping zones on the exterior surface of the housing side wall.

14. The litter pod system of claim 1, wherein the housing side wall further comprises a tapered flange extending outward from a top perimeter of the housing side wall.

15. The litter pod system of claim 14, wherein the pod side wall further comprises a lip extending outward from a top perimeter of the pod side wall.

16. The litter pod system of claim 15, wherein the tapered flange defines a channel for connection with the lip of the pod side wall.

17. The litter pod system of claim 14, wherein the tapered flange further comprises two cut outs on opposing sides of the housing side wall.

18. The litter pod system of claim 1, wherein the litter pod system further comprises one or both of an upper frame and a hood assembly.

19. The litter pod system of claim 18, wherein one or both of the upper frame and the hood assembly are configured to be directly connected to the housing base.

20. The litter pod system of claim 19, wherein the upper frame defines an outer wall and a skirt portion configured to cover at least a portion of the housing side wall when the upper frame is in direct connection with the housing base.

21. The litter pod system of claim 1, wherein the litter pod is disposable and replaceable.

22. The litter pod system of claim 1, wherein one or both of the flexible, polymer material and the substantially rigid polymer material are selected from the group consisting of polyethylene terephthalate (PET), polytetrafluoroethylene (PTFE), high-density polyethylene (HDPE), low-density polyethylene (LDPE), polyvinyl chloride (PVC), polypropylene (PP), polystyrene (PS), polyethylene (PE), acrylonitrile butadiene styrene (ABS), and combinations thereof.

23. The litter pod system of claim 1, wherein one or both of the flexible polymer material and the substantially rigid polymer material have a Shore D Hardness of at least about 50.

24. The litter pod system of claim 1, wherein one or both of the flexible, polymer material and the substantially rigid polymer material have a contact angle of at least about 70.

25. The litter pod system of claim 1, wherein one or both of the flexible, polymer material and the substantially rigid polymer material comprise one or more additives or surface coatings.

26. The litter pod system of claim 1, wherein the flexible, polymer material has a thickness in the range of about 0.01 mm to about 1.0 mm.

27. The litter pod system of claim 1, wherein the substantially rigid polymer material has a thickness in the range of about 1.25 mm to about 5.0 mm.

28. The litter pod system of claim 1, wherein the litter pod is formed of a fiber-based material that has been at least partially coated by the flexible, polymer material.

29. The litter pod system of claim 28, wherein the fiber-based material is paper or paperboard formed of natural or synthetic fibers.
